(19) United States
(12) Patent Application Publication
(10) Pub. No.: US 2016/0295809 A1
(43) Pub. Date: Oct. 13, 2016

(54) ENERGY SAVING APPARATUS AND METHOD FOR USING THE SAME FOR PLANTING RACKS

(71) Applicant: Industrial Technology Research Institute, HSIN-CHU (TW)

(72) Inventors: TIEN-FU HUANG, Hsinchu County (TW); SHIH-YING CHIANG, Hualien County (TW); YU-HSIANG LIU, Taipei City (TW)

(21) Appl. No.: 14/747,524

(22) Filed: Jun. 23, 2015

(30) Foreign Application Priority Data
Apr. 10, 2015 (TW) 104111665

(51) Int. Cl. A01G 9/12; A01G 9/14; A01G 13/08; A01G 7/06

(52) U.S. Cl. CPC A01G 9/12; A01G 7/06; A01G 9/14; A01G 13/08

(57) ABSTRACT

An energy saving apparatus includes at least a planting rack having at least a panel and a collecting part, a wind pipe, an air conditioner, and an air blower. The panel further has a flow path, and the collecting part is located at a bottom of the panel communicative with the flow path. The wind pipe with bottom nozzles is located above the panel. The air conditioner coupled to the wind pipe is to spray a cool air to the panel through the nozzles. The air blower coupled between the collecting part and the air conditioner is to extract air, so that the cool air can flow from the top to the bottom of the panel, then flow down along the flow path to the collecting part, and finally be supplied back to the air blower for further recycling the cool air to the air conditioner.

### CROSS REFERENCE TO RELATED APPLICATION

This application also claims priority to Taiwan Patent Application No. 104111665 filed in the Taiwan Patent Office on Apr. 10, 2015, the entire content of which is incorporated herein by reference.

### TECHNICAL FIELD

The present disclosure relates to an energy saving apparatus for planting racks and method using the apparatus, and more particularly to the energy saving apparatus and the accompanying method that can control the environmental temperature of the planting racks so as to benefit growth of the plants cultivated on the planting racks.

### BACKGROUND

In the art of agriculture, intensive cultivation of plants in the open field with the help of agricultural chemicals, pesticides, chemical fertilizers or insectifuges is usually seen. However, the aforesaid agricultural chemicals, pesticides, chemical fertilizers and insectifuges are all negative and, actually, harmful to the environment.

The conventional flowerpot cultivation may have merits in blocking the insect and/or disease pathway from soils during the growth of the cultivated plants. Namely, the transmission of any disease and insect pest to the plants the through the cultivation soil can be substantially prohibited by applying the flowerpot cultivation.

Nevertheless, the conventional flowerpot cultivation of plants does have shortcomings in costing labors, reducing the utilization rate of unit area, exhausting the water resources and some other economic considerations. Therefore, a planting rack for mounting a plurality of conventional flowerpots is introduced to go with the green house for controlling, mostly minimizing, growth periods of the cultivated plants.

Though the introduction of the green house may be advantageous to the growth control of the cultivated plants, yet some local climate factors may still affect the utilization of the green house. Typically, in the low-altitude areas, the heat could be accumulated inside the green house to disturb the growth of the cultivated plants during the summer time. On the other hand, in the high-latitude areas, the internal temperature of the green house may be hard to be raised and thus slower the growth of the cultivated plants due to lack of sunshine during the winter time.

In resolving the aforesaid heat disturbance and localized low-temperature problem, though a large-capacity air-conditioning system for providing cool air or heated air may be introduced to successfully overcome the foregoing negative situations inside the green house, yet such a resort may imply a tremendous consumption in expensive energy.

### SUMMARY

The present disclosure is to provide an energy saving apparatus for planting racks, comprising:

at least one planting rack, having at least one panel and at least one collecting part, the panel having a flow path, the collecting part being located at a bottom of the panel and communicative with the flow path;

at least one wind pipe, having a plurality of nozzles at a bottom thereof, the plurality of nozzles being located above the respective panel

at least one air conditioner, coupled to the at least one wind pipe, the air conditioner being used to provide a cool air spraying to the at least one panel through the plurality of nozzles; and

at least one air blower, coupled to the at least one collecting part and the at least one air conditioner.

The present disclosure is further to provide an energy saving apparatus for planting racks, comprising:

at least one planting rack, having at least one shelving frame and at least one collecting part, the shelving frame being formed as stairstep structure having a plurality of shelve levels, each of the shelve levels of the shelving frame further having a plurality of mounting holes and at least one air-sucking hole, the shelving frame further having a flow path, the collecting part being located at a bottom of the shelving frame and communicative with the flow path;

at least one wind pipe, having a plurality of nozzles at a bottom thereof, the plurality of nozzles being located above the respective shelving frame;

at least one air conditioner, coupled to the at least one wind pipe, the air conditioner being used to provide a cool air sprayed to the at least one shelving frame through the plurality of nozzles; and

at least one air blower, coupled to the at least one collecting part and the at least one air conditioner.

The present disclosure is further to provide an energy saving apparatus for planting racks, comprising:

at least one planting rack, having at least one panel and at least one collecting part, the panel having a flow path, the collecting part being located at a bottom of the panel and communicative with the flow path;

at least one air blower, coupled to the collecting part; and

at least one air-heating device, coupled to the air blower.

The present disclosure is further to provide an energy saving apparatus for planting racks, comprising:

at least one planting rack, having at least one shelving frame and at least one collecting part, the shelving frame being formed as a stairstep structure having a plurality of shelve levels, each of the shelve levels of the shelving frame further having a plurality of mounting holes and at least one air-sucking hole, the shelving frame further having a flow path, the collecting part being located at a bottom of the shelving frame and communicative with the flow path;

at least one air blower, coupled to the collecting part; and

at least one air-heating device, coupled to the air blower.

The present disclosure is further to provide a planting rack, comprising:

at least one panel, having a plurality of fluid-containing cavities; and

at least one fluid-guiding plate, mounted at one side of the at least one panel;

characterized on that the fluid-guiding plate is furnished to an end of a surrounding flange of the panel so as to form a narrow channel acting as a flow path between the fluid-guiding plate and the panel.

The present disclosure is further to provide an energy saving method for planting racks, comprising the steps of:

providing a cool air, detecting either at least one environmental temperature at each of the respective planting racks in a green house or an interior temperature of the green house, turning on an air conditioner to provide a cool air if any of the interior temperature and the at least one environmental temperature exceeds a preset temperature;

recycling the cool air, an air blower being turned on to suck the cool air into the planting rack and then forward the cool air to the air conditioner as the cool air flows to the planting rack;

terminating the supply of the cool air, turning off the air conditioner if the interior temperature and the at least one environmental temperature are lower than the preset temperature; and

detecting continuously the interior temperature and the at least one environmental temperature, turning on the air conditioner if any of the interior temperature and the at least one environmental temperature exceeds the preset temperature, turning off the air conditioner if both the interior temperature and the at least one environmental temperature are lower than the preset temperature.

The present disclosure is further to provide an energy saving method for planting racks, comprising the steps of:

providing a heated air, detecting either at least one environmental temperature at each of the respective planting racks in a green house or an interior temperature of the green house, turning on an air-heating device to provide a heated air to an air blower if any of the interior temperature and the at least one environmental temperature is lower than a preset temperature, the air blower flowing the heated air out of the respective planting rack;

terminating the providing of the heated air, turning off the air-heating device if all the interior temperature and the at least one environmental temperature exceed the preset temperature; and

detecting continuously the interior temperature and the at least one environmental temperature, turning off the air-heating device if both the interior temperature and the at least one environmental temperature exceed the preset temperature, turning on the air-heating device if any of the interior temperature and the at least one environmental temperature is lower than the preset temperature.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic view of a first embodiment of the energy saving apparatus for planting racks in this disclosure;

FIG. 2 is a schematic perspective view of an exemplary embodiment of FIG. 1;

FIG. 3 is a schematic exploded view of FIG. 2;

FIG. 4 is a schematic perspective view of the panel of FIG. 2;

FIG. 5 is a schematic cross-sectional view of a portion of FIG. 2, showing the panel, the collecting part and the fluid-guiding plate;

FIG. 6 demonstrates schematically a green house mounted with at least one energy saving apparatus and at least one planting rack of this disclosure;

FIG. 7 is a schematic perspective view of a second embodiment of the energy saving apparatus for planting racks in this disclosure; and

FIG. 8 is a schematic view of a third embodiment of the energy saving apparatus for planting racks in this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

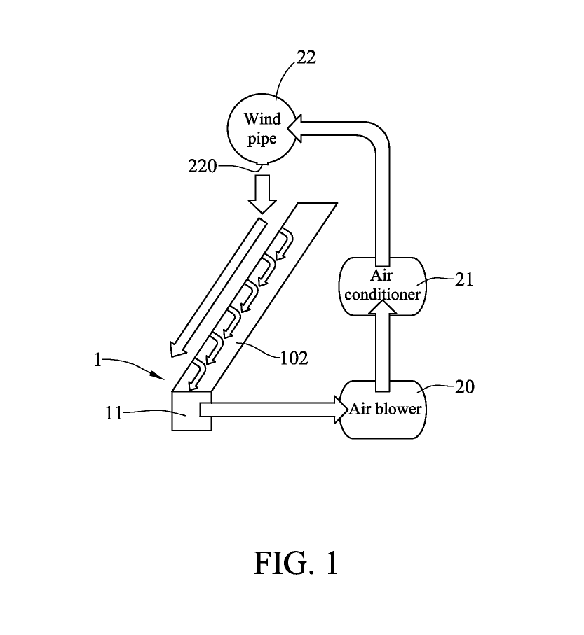

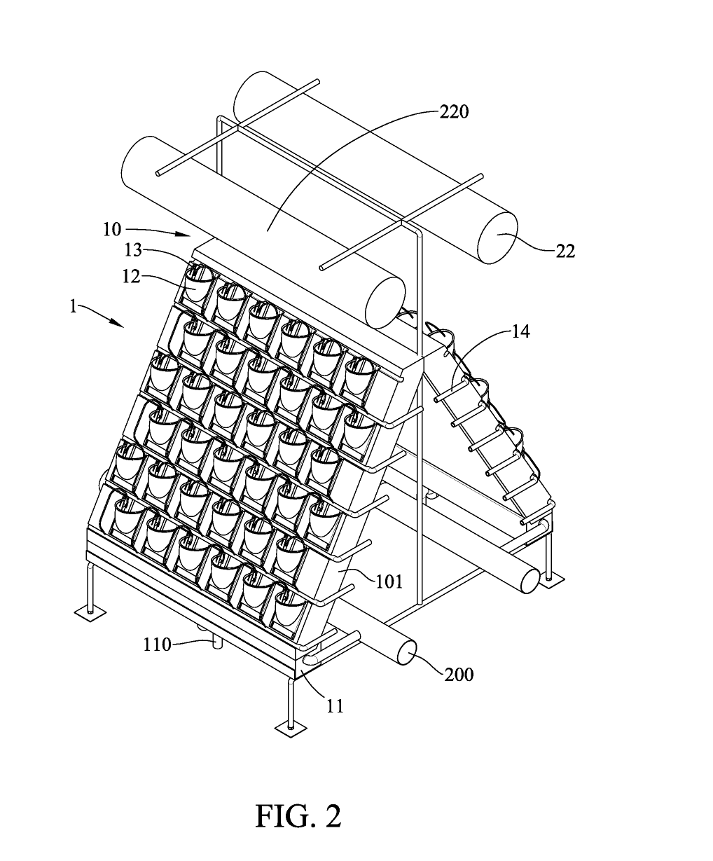

Referring to FIG. 1 and FIG. 2, a first embodiment of the preferred energy saving apparatus for planting racks in this disclosure is shown. The energy saving apparatus includes at least one planting rack 1, at least one air conditioner 21, at least one air blower 20 and at least one wind pipe 22.

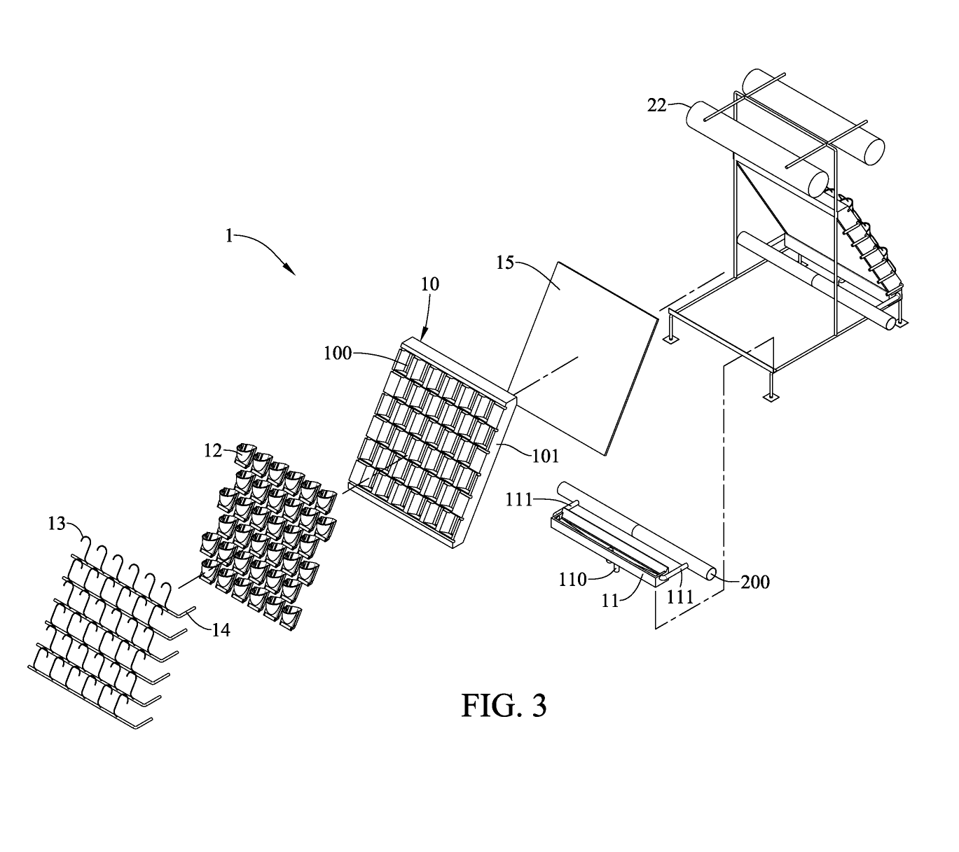

Referring further to FIG. 3, the planting rack 1 in this embodiment is formed as an A-shape planting rack having at least one panel 10, at least one collecting part 11, a plurality of planting containers 12, a plurality of fluid-supplying pipes 14, a plurality of fluid-injecting pipes 13 and at least one fluid-guiding plate 15.

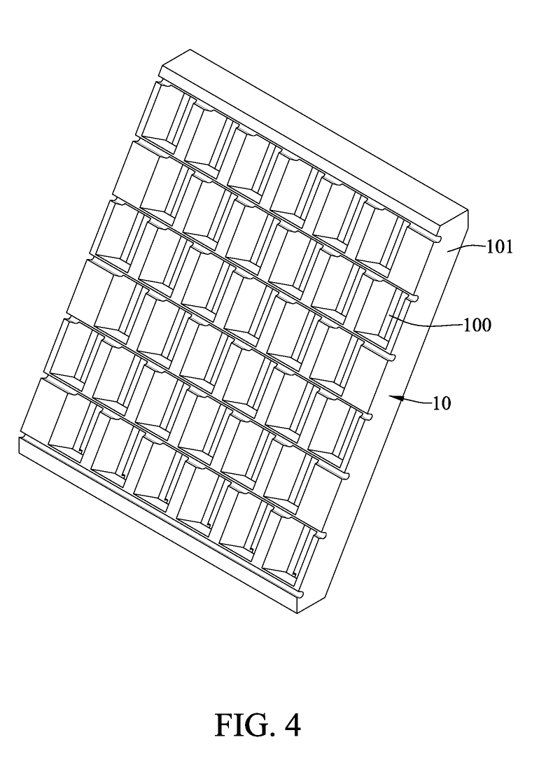

Referring now to FIG. 2, FIG. 3 and FIG. 4, in this embodiment, the two panels 10 to form an A-shape are obliquely and symmetrically mounted. Each of the panels 10 has a surrounding perimeter flange 101 and a plurality of fluid-containing cavities 100 thereinside, in which the fluid-containing cavities 100 are arranged in a stairstep manner.

Each collecting part 11 is mounted to a bottom of the corresponding panel 10, and the bottom further has a fluid outlet 110 formed as a curved shape for allowing a fluid to stay in a curved portion thereof. The purpose of the curved portion of the fluid outlet 110 is to prevent the fluid from flowing back to the collecting part 11 while the air blower 20 is extracting air. Alternatively, the fluid outlet 110 can include a check valve for avoiding the invasion of foreign air through the fluid outlet 110. As shown, the fluid outlet 110 is coupled to a fluid-accumulating device, such as a pump or a vacuum device.

Each of the planting containers 12 is located at the respective fluid-containing cavity 100. Each of the fluid-supplying pipes 14 is located at the panel 10 by neighboring to the respective planting container 12. Each of the fluid-injecting pipes 13 has one end coupled to the respective fluid-supplying pipe 14, while another end thereof is extended to a top of the respective planting container 12. The fluid-supplying pipe 14 is further coupled to a fluid-supplying system, such that the fluid-supplying system can supply the fluid to each of the fluid-supplying pipes 14.

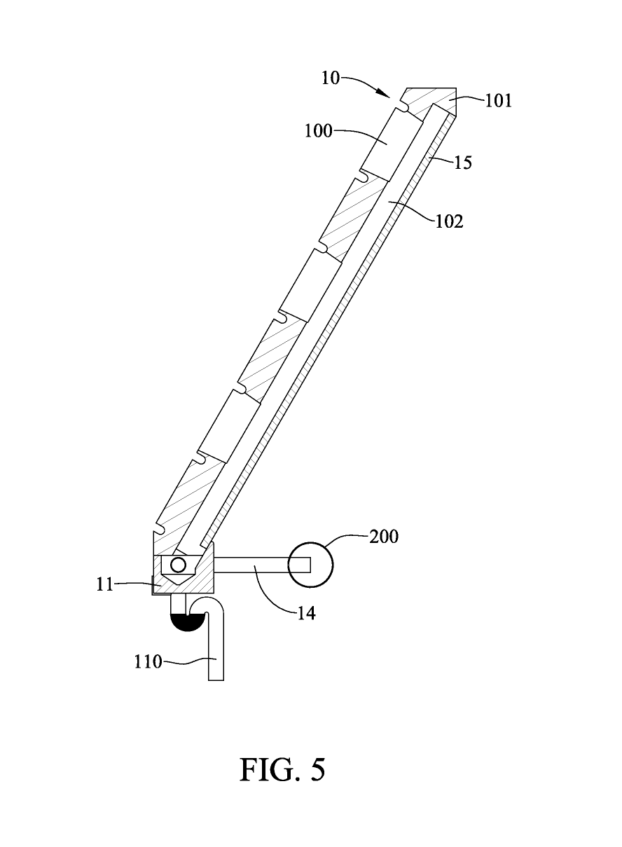

Referring further to FIG. 5, each of the two fluid-guiding plates 15 is furnished to an end of a surrounding flange 101 so as to form a narrow channel 102 between the fluid-guiding plate 15 and the panel 10. As shown in FIG. 5, the narrow channel 102 can act as a flow path (also labeled as 102 thereafter) to flow the fluid or the air into the cool air down into the collecting partl 1.

Referring to FIG. 1 through FIG. 3, the wind pipe 22 is located by neighboring to the respective panel 10. In this embodiment, the two wind pipes 22 are located to corresponding top portions of the respective panels 10. Each of the wind pipes 22 has a plurality of nozzles 220 located at a bottom thereof, in which the nozzles 220 are constructed by facing the respective panel 10 located beneath the wind pipe 22. The wind pipe 22 is coupled to the air conditioner 21 so as to allow the cool air to flow forcedly or be sprayed into each of the fluid-containing cavities 100 of the panel 10 located under the wind pipe 22, and the cool air is then further led to the flow path 102 through the fluid-containing cavities 100.

The air blower 20 has at least one wind-collecting pipe 200, in which one end of the wind-collecting pipe 200 is connected at the air blower 20. The wind-collecting pipe 200 further connects with the collecting part 11 through at least one connection pipe 111. Since the fluid outlet 110 is curve-shaped as described above, so the fluid can be stayed inside the curved portion thereof. Alternatively, the fluid outlet 110 can include a check valve. With either of the arrangements, the foreign air in the fluid outlet 110 can be prevented from entering the connecting part 11 and the connection pipes 111, while the air blower 20 is working. In addition, the air blower 20 is further coupled to the air conditioner 21.

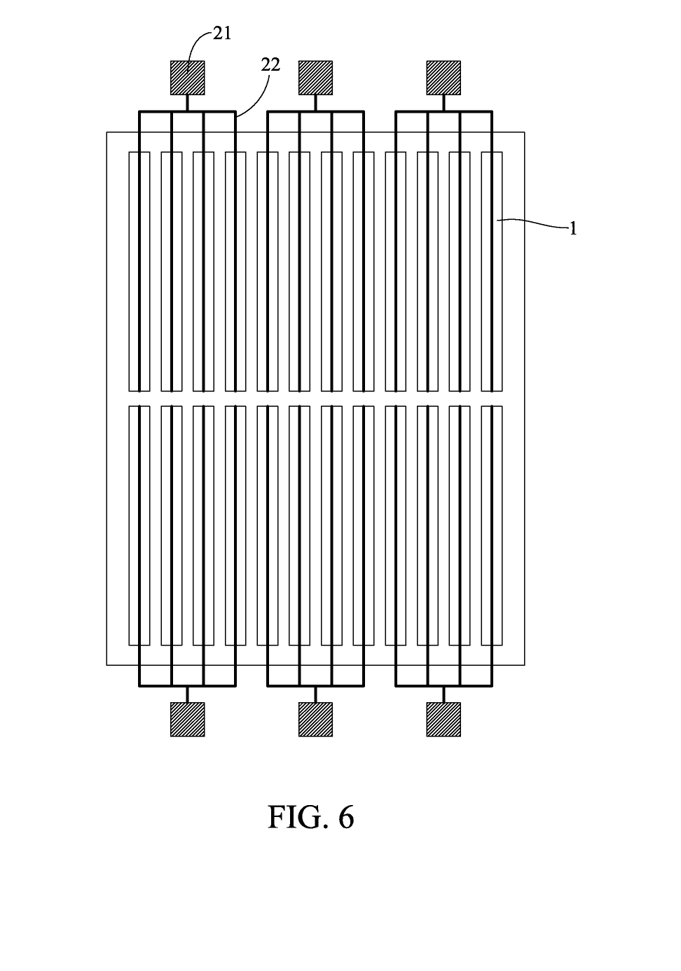

Referring now to FIG. 6, an embodiment having at least one energy saving apparatus (six shown in the figure) and at least one planting rack to be mounted inside a green house is schematically presented. As shown, each individual air conditioner 21 provides the cool air to a plurality of the wind pipes 22 (four shown to each air conditioner 21). Resembled to the embodiment shown in FIG. 2, each of these four wind pipes 22 is responsive to two planar planting racks formed as an A-shape located under the corresponding wind pipe 22. In this embodiment of FIG. 6, six sets are included, and each set is consisted of one air conditioner 21, four wind pipes 22 and four corresponding A-shaped planting racks 1. However, the aforesaid application numbers in the air conditioner 21, the wind pipe 22 and the A-shaped planting rack 1 can be varied per practical requirement. Now, referring to FIG. 1, FIG. 2 and FIG. 6, the energy saving method for the planting racks 1 in this disclosure can comprise following steps 1-5.

Step 1: Prepare a green house with a plurality of the planting racks 1 mounted thereinside. On top of every two planting racks 1, a plurality of the wind pipes 22 are mounted. Each of the wind pipes 22 is corresponding to the respective panel 10 on the planting rack 1. At least one air conditioner 21 is mounted to supply cool air to the plurality of the wind pipes 22. Each of the planting containers 12 contains a flowerpot for the cultivated plant, or the cultivated plant can be grown directly in the planting container 12. As described above, at least one planting rack 1 is there to go with the air conditioner 21.

Step 2: Provide the cool air. Detect the environmental temperature at each planting rack 1 in the green house. If any of the detected environmental temperature around a specific planting rack 1 inside the green house is over a preset temperature, then the respective air conditioner 21 corresponding to the planting rack 1 detected to have the abnormal environmental temperature is turned on to supply the cool air to the respective wind pipes 22. Similarly, if the temperature inside the green house is over the preset temperature, then all the air conditioners 21 would be turned on to supply the cool air to every wind pipes 22 inside the green house.

Step 3: Recycle the cool air. As shown in FIG. 1, when the cool air is flowed to the surface of the panel 10 through the nozzles 220 of the wind pipes 22, the air blower 20 is turned on to extract air, such that the cool air can be drawn forcedly from the top of the panel 10 to the bottom of the panel 10. Also, since of the existence of the flow path 102 between the fluid-guiding plate 15 and the panel 10 and the communication in space between the flow path 102 and the collecting part 11, the cool air penetrating each individual fluid-containing cavity 100 of the panel 10 would then be guided to the collecting part 111 by the flow path 102. The cool air entering the collecting part 11 would then be led to the air blower 20 via the wind-collecting pipe 200 and finally be returned back to the respective air conditioners 21 from the air blower 20.

In addition, the fluid from the fluid-supplying pipe 14 is injected into the respective planting containers 12 through the corresponding fluid-injecting pipes 13 so as to irrigate the plants cultivated in the respective planting containers 12 by sprinkling. Besides the irrigating purpose, the fluid can also serve a purpose of cooling down the temperature. While the fluid is irrigated by sprinkling to the respective planting container 12, part of the fluid would be leaked to the flow path 102 through the corresponding fluid-containing cavity 100. The fluid-guiding plate 15 prevents the fluid entering the flow path 102 from arbitrarily splashing and further guides the fluid down to the collecting part 11. The fluid in the collecting part 11 is then flowed out the collecting part 11 through the fluid outlet 110, or alternatively recycled to the fluid-supplying system for being further supplied to the fluid-supplying pipe 14. Since both the heights of the wind-collecting pipe 200 and the collecting part 11 are higher than that of the fluid outlet 110, so when the fluid and the cool air are in the collecting part 11 simultaneously, the fluid and the cool air are separated in a two-phase separation state so as to avoid the fluid to be sucked into the air blower 20.

In addition, the oblique-mounted panel 10 can also help to lead the flow of the cool air. In this embodiment, the flow path 102 formed between the fluid-guiding plate 15 and the panel 10 can serve a purpose of guiding the fluid and/or the cool air to the collecting part 11.

Step 4: Terminate the supply of the cool air. If all the detected environmental temperatures and the interior temperature of the green house are all lower than the preset temperature, then turn off the air conditioner 21 and the air blower 20.

Step 5: Keep detecting the temperatures. Detect continuously the interior temperature of the green house and all the environmental temperatures of the respective planting racks 1. If any of the interior temperature and the environmental temperatures exceeds the preset temperature, go back to Step 2. If all the interior temperature and the environmental temperatures are lower than the preset temperature, then the air conditioner 21 keep motionless.

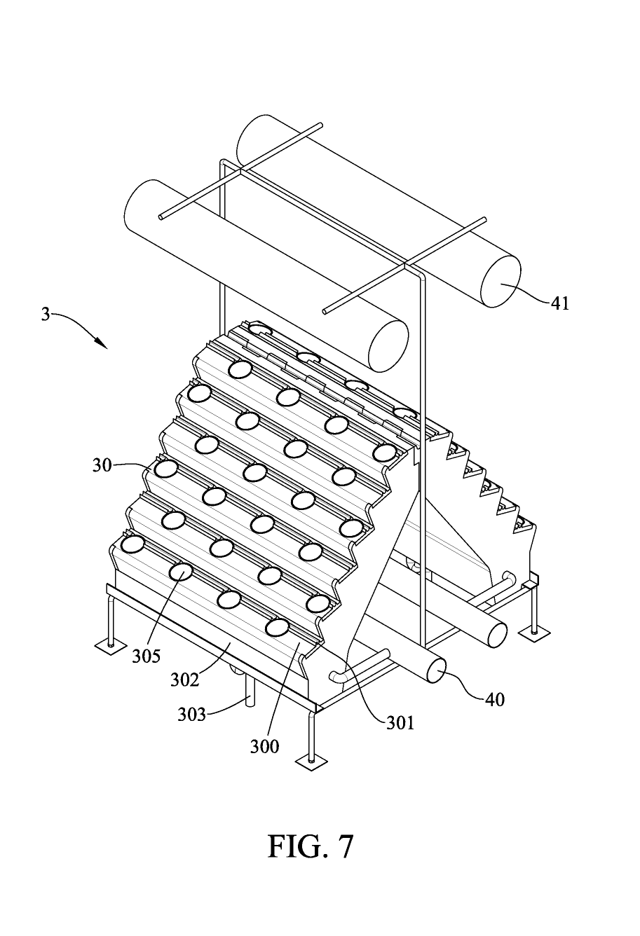

Referring now to FIG. 7, a second embodiment of the energy saving apparatus for planting racks 3 in this disclosure is schematically shown. In this embodiment, the arrangement of the air blower, the air conditioner, the wind pipe 41 and the wind-collecting pipe 40 are all resembled to that shown in the aforesaid first embodiment, and hence details thereabout would be omitted herein.

The planting rack 3 has at least one shelving frame 30 arranged in an oblique manner. In this embodiment, either of the two shelving frames 30 is formed as a stairstep structure having a plurality of shelve levels 300, and each the shelve level 300 has a plurality of mounting holes 305 and at least one air-sucking hole 301. The shelving frame 30 has a collecting part 302 located at a bottom thereof, and the collecting part 302 is coupled to the wind-collecting pipe 40. A bottom of the collecting part 302 further has a fluid outlet 303. At the back side of the oblique mounted shelving frame 30, a fluid-guiding plate is mounted so as to form a narrow channel between the shelving frame 30 and the fluid-guiding plate for performing a flow path down to the collecting part 302. In this embodiment, the mounting hole 305 is to accommodate a medium bag for plant cultivation.

In the first embodiment of the energy saving method as described above, the planting racks 3 are mounted inside the green house. As the environmental temperature of a planting rack 3 is detected to be over the preset temperature, the corresponding air conditioner is introduced to provide the cool air to the wind pipe 41, and then the wind pipe 41 conveys the cool air to the shelving frame 30. The cool air is sent to the shelving frame 30 through the air-sucking holes 301, then guided to the collecting part 302, then extracted by the air blower, and finally sent back to the air conditioner.

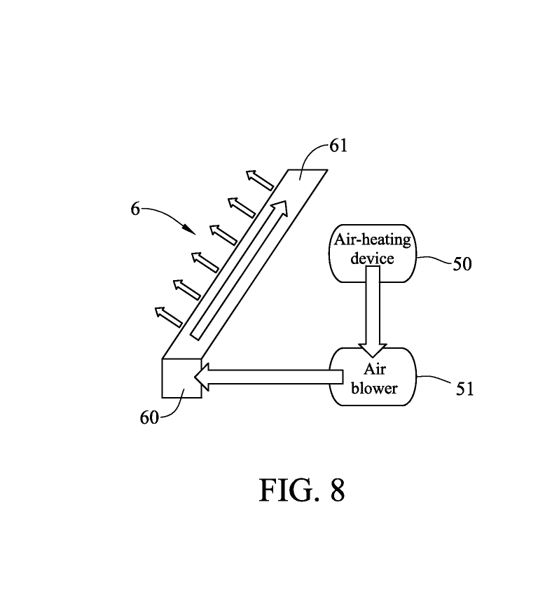

Referring now to FIG. 8, a third embodiment of the energy saving apparatus for planting racks 6 in this disclosure is schematically shown. The energy saving apparatus includes at least one planting rack 6, at least one air blower 51 and at least one air-heating device 50.

In this third embodiment, the panel 61 of the planting rack 6 can apply the aforesaid panel of the first embodiment of the energy saving apparatus, and/or the planting rack 6 can apply the aforesaid planting rack of the second embodiment of the energy saving apparatus.

The air-heating device 50 is coupled to the air blower 51, the air blower 51 is coupled to the wind-collecting pipe, and the wind-collecting pipe is coupled to the collecting part 60 located at the bottom of the panel 61.

Referring also to FIG. 8, a second embodiment of the energy saving method for the planting racks 6 in this disclosure can comprise following steps 1-4.

Step 1: Prepare a green house with a plurality of the planting racks 6 mounted thereinside. At least two planting racks 6 are arranged to couple an air-heating device 21. Each of the planting racks 6 is to grow a plurality of plants. As described above, at least one air-heating device 21 can be included to pair at least one planting rack 6.

Step 2: Provide the heated air. Detect the environmental temperature at each planting rack 6 in the green house, or detect the interior temperature of the green house. If any of the detected environmental temperature around a specific planting rack 6 inside the green house is lower than a preset temperature, or if the interior temperature inside the green house is lower than the preset temperature, then the air-heating device 50 is turned on to provide a heated air to the air blower 51. The air blower 51 forwards the heated air to the wind-collecting pipe, and then to the collecting part 60. Guided by the panel 61, the heated air is then charged to and further flowed out of the fluid-containing cavities at every level of the panel 61, such that the heated air can be supplied to the plant grown in each individual fluid-containing cavity. If the planting rack 6 is shaped as the aforesaid shelving frame, then the heated air is flowed out through the air-sucking hole.

Step 3: Terminate the supply of the heated air. If all the detected environmental temperatures and the interior temperature of the green house are all higher than the preset temperature, then turn off the air-heating device 50 and the air blower 51.

Step 4: Keep detecting the temperatures. Detect continuously the interior temperature of the green house and all the environmental temperatures of the respective planting racks 6. If all the interior temperature and the environmental temperatures are still higher than the preset temperature, then the air-heating device 50 keeps motionless. However, if any of the interior temperature and the environmental temperatures is lower than the preset temperature, go back to Step 2.

According to the disclosure, in the first and second embodiments of the energy saving apparatus for planting racks and in the first embodiment of the energy saving method for planting racks, the air blower is used to recycle the cool air, and the recycled cool air is further supplied to the air conditioner, such that the load upon the air conditioner can be substantially reduced.

In addition, the air conditioner adopted in this disclosure to pair at least one planting rack is to supply the cool air directly and individually to at least one planting rack, not to the empty space of the green house. Though the number of the air conditioners might increase, yet practically the total accumulated capacity of the air conditioners in the green house is still less than that of a single air conditioner used to charge the empty space of the green house, such that the advantages in energy saving and carbon reduction contributed by this disclosure are obvious.

Further, by providing the oblique mounting to the panel or the shelving frame in this disclosure so as to guide the flow of the cool air and/or the heated air, the cool air and/or the heated air can be evenly distributed over the panel or the shelving frame.

Furthermore, in the third embodiment of the energy saving apparatus for planting racks and in the second embodiment of the energy saving method for planting racks according to the present disclosure, an air-heating device is introduced to pair at least one planting rack, so as to provide the heated air to at least one planting rack, not to the empty space of the green house. Though the number of the air-heating devices might increase, yet practically the total accumulated capacity of the air-heating devices in the green house is still far less than that of a single air-heating device used to charge the empty space of the green house, such that the advantages in energy saving and carbon reduction contributed by this disclosure are obvious.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An energy saving apparatus for planting racks, comprising:
at least one planting rack, having at least one panel and at least one collecting part, the panel having a flow path, the collecting part being located at a bottom of the panel and communicative with the flow path;
at least one wind pipe, having a plurality of nozzles at a bottom thereof, the plurality of nozzles being located above the respective panel;
at least one air conditioner, coupled to the at least one wind pipe, the air conditioner being used to provide a cool air sprayed to the at least one panel through the plurality of nozzles; and
at least one air blower, coupled to the at least one collecting part and the at least one air conditioner.

2. The energy saving apparatus for planting racks of claim 1, where the air blower has a wind-collecting pipe coupled to the collecting part through a connection pipe, one end of the wind-collecting pipe being coupled to the air blower.

3. The energy saving apparatus for planting racks of claim 1, where the collecting part has a curve-shaped fluid outlet.

4. The energy saving apparatus for planting racks of claim 1, where the planting rack is an A-shaped planting rack having two symmetrically oblique-mounted panels, at least one fluid-guiding plate, a plurality of planting containers, a plurality of fluid-supplying pipe and a plurality of fluid-injecting pipes, the fluid-guiding plate being furnished to an end of a surrounding flange of the panel so as to form a narrow channel acting as the flow path between the fluid-guiding plate and the panel, each the planting container being accommodated in the respective fluid-containing cavity, each the fluid-supplying pipe being mounted to the respective panel by neighboring the respective planting container, each the fluid-injecting pipe having one end thereof coupled to the respective fluid-supplying pipe while another end thereof is extended to the top of the respective planting container.

5. The energy saving apparatus for planting racks of claim 1, where the panel has a plurality of fluid-containing cavities, the cool air being sprayed to the fluid-containing cavities of the panel through the nozzles of the wind pipe and then flowing to the flow path through the fluid-containing cavities.

6. An energy saving apparatus for planting racks, comprising:
at least one planting rack, having at least one shelving frame and at least one collecting part, the shelving frame being formed as a stairstep structure having a plurality of shelve levels, each of the shelve levels of the shelving frame further having a plurality of mounting holes and at least one air-sucking hole, the shelving frame further having a flow path, the collecting part being located at a bottom of the shelving frame and communicative with the flow path;
at least one wind pipe, having a plurality of nozzles at a bottom thereof, the plurality of nozzles being located above the respective shelving frame;
at least one air conditioner, coupled to the at least one wind pipe, the air conditioner being used to provide a cool air sprayed to the at least one shelving frame through the plurality of nozzles; and
at least one air blower, coupled to the at least one collecting part and the at least one air conditioner.

7. The energy saving apparatus for planting racks of claim 6, wherein the shelving frame has a plurality of fluid-containing cavities, the cool air being sprayed to the fluid-containing cavities of the shelving frame through the nozzles of the wind pipe and then flowing to the flow path through the fluid-containing cavities.

8. The energy saving apparatus for planting racks of claim 6, where the air blower has a wind-collecting pipe coupled to the collecting part through a connection pipe, one end of the wind-collecting pipe being coupled to the air blower.

9. The energy saving apparatus for planting racks of claim 6, where the collecting part has a curve-shaped fluid outlet.

10. The energy saving apparatus for planting racks of claim 6, where the planting rack is an A-shaped planting rack having two symmetrically oblique-mounted panels, at least one fluid-guiding plate, the fluid-guiding plate being fixed to one side of a surrounding perimeter flange of the shelving frame so as to form a narrow channel acting as the flow path between the fluid-guiding plate and the shelving frame.

11. An energy saving apparatus for planting racks, comprising:
at least one planting rack, having at least one panel and at least one collecting part, the panel having a flow path, the collecting part being located at a bottom of the panel and communicative with the flow path;
at least one air blower, coupled to the collecting part; and
at least one air-heating device, coupled to the air blower.

12. The energy saving apparatus for planting racks of claim 11, where the air blower has a wind-collecting pipe coupled to the collecting part through a connection pipe, one end of the wind-collecting pipe being coupled to the air blower.

13. The energy saving apparatus for planting racks of claim 11, where the collecting part has a curve-shaped fluid outlet.

14. The energy saving apparatus for planting racks of claim 12, where the planting rack is an A-shaped planting rack having two symmetrically oblique-mounted panels, at least one fluid-guiding plate, a plurality of planting containers, a plurality of fluid-supplying pipe and a plurality of fluid-injecting pipes, the fluid-guiding plate being furnished to an end of a surrounding flange of the panel so as to form a narrow channel acting as the flow path between the fluid-guiding plate and the panel, each the planting container being accommodated in the respective fluid-containing cavity, each the fluid-supplying pipe being mounted to the respective panel by locating beneath the respective planting container, each the fluid-injecting pipe having one end thereof coupled to the respective fluid-supplying pipe while another end thereof is extended to the top of the respective planting container.

15. An energy saving apparatus for planting racks, comprising:
at least one planting rack, having at least one shelving frame and at least one collecting part, the shelving frame being formed as a stairstep structure having a plurality of shelve levels, each of the shelve levels of the shelving frame further having a plurality of mounting holes and at least one air-sucking hole, the shelving frame further having a flow path, the collecting part being located at a bottom of the shelving frame and communicative with the flow path;
at least one air blower, coupled to the collecting part; and
at least one air-heating device, coupled to the air blower.

16. The energy saving apparatus for planting racks of claim 15, where the air blower has a wind-collecting pipe coupled to the collecting part through a connection pipe, one end of the wind-collecting pipe being coupled to the air blower.

17. The energy saving apparatus for planting racks of claim 15, where the planting rack is an A-shaped planting rack having two symmetrically oblique-mounted panels, at least one fluid-guiding plate, the fluid-guiding plate being fixed to one side of a surrounding perimeter flange of the shelving frame so as to form a narrow channel acting as the flow path between the fluid-guiding plate and the shelving frame, each the planting container being accommodated in the respective fluid-containing cavity, each the fluid-supplying pipe being mounted to the respective shelving frame by locating beneath the respective planting container, each the fluid-injecting pipe having one end thereof coupled to the respective fluid-supplying pipe while another end thereof is extended to top of the respective planting container.

18. A planting rack, comprising:
at least one panel, having a plurality of fluid-containing cavities; and
at least one fluid-guiding plate, mounted at one side of the at least one panel;
characterized on that the fluid-guiding plate is furnished to an end of a surrounding flange of the panel so as to form a narrow channel acting as a flow path between the fluid-guiding plate and the panel.

19. An energy saving method for planting racks, comprising the steps of:
providing a cool air, detecting either at least one environmental temperature at each of the respective planting racks in a green house or an interior temperature of the green house, turning on an air conditioner to provide a cool air if any of the interior temperature and the at least one environmental temperature exceeds a preset temperature;
recycling the cool air, an air blower being turned on to suck the cool air into the planting rack and then to forward the cool air to the air conditioner as the cool air flows to the planting rack;
terminating the supply of the cool air, turning off the air conditioner if any of the interior temperature and the at least one environmental temperature is lower than the preset temperature; and
detecting continuously the interior temperature and the at least one environmental temperature, turning on the air conditioner if any of the interior temperature the at least one environmental temperature exceeds the preset temperature, turning off the air conditioner if any of the interior temperature and the at least one environmental temperature is lower than the preset temperature.

20. The energy saving method for planting racks of claim 19, prior to the step of providing a cool air, further including a step of preparing the green house with a plurality of planting racks, at least one of the plurality of planting racks being paired with one said air conditioner.

21. An energy saving method for planting racks, comprising the steps of:
providing a heated air, detecting either at least one environmental temperature at each of the respective planting racks in a green house or an interior temperature of the green house, turning on an air-heating device to provide a heated air to an air blower if any of the interior temperature and the at least one environmental temperature is lower than a preset temperature, the air blower flowing the heated air out of the respective planting rack;
terminating the providing of the heated air, turning off the air-heating device if both the interior temperature and the at least one environmental temperature exceed the preset temperature; and
detecting continuously the interior temperature and the at least one environmental temperature, turning off the air-heating device if all the interior temperature and the at least one environmental temperature exceed the preset temperature, turning on the air-heating device if any of the interior temperature and the at least one environmental temperature is lower than the preset temperature.

22. The energy saving method for planting racks of claim 21, prior to the step of providing a heated air, further including a step of preparing the green house with a plurality of planting racks, at least one of the plurality of planting racks being paired with one said air-heating device.
